(19) United States
(12) Patent Application Publication
(10) Pub. No.: US 2006/0078175 A1
(43) Pub. Date: Apr. 13, 2006

(54) Hand-held diagnostic display unit including biometric characteristic security system

(75) Inventor: Roy Steven Brozovich, Santa Clara, CA (US)

Correspondence Address: MCDERMOTT WILL & EMERY LLP, 600 13TH STREET, N.W., WASHINGTON, DC, 20005-3096, US

(73) Assignee: SNAP-ON TECHNOLOGIES, INC. A DELAWARE CORPORATION, LINCOLNSHIRE, IL (US)

(21) Appl. No.: 10/961,211

(22) Filed: Oct. 12, 2004

(51) Int. Cl. G06K 9/00

(52) U.S. Cl. 382/124; 340/5.83; 701/29

(57) ABSTRACT

A vehicle diagnostic display unit including a case, a display screen disposed within a front portion of the case, and a main support coupled to a side of the case and having a finger compartment for receiving a user's fingers to allow the user to lift the vehicle diagnostic display unit using one hand. A navigation pad is disposed on a front surface of the main support and the main support is configured to allow a user to simultaneously lift the diagnostic display unit and access the navigation pad with a thumb. The unit also includes a fingerprint identification system including a scanner for scanning an image of a fingerprint of the user. The scanner is fitted on the navigation pad so that the user's thumb naturally rests on the fingerprint scanner when the user lifts the diagnostic display unit and accesses the navigation pad with the thumb.

### FIELD OF THE DISCLOSURE

The present disclosure generally relates to motor vehicle diagnostic equipment and methods and, more specifically, to a hand-held automotive diagnostic display unit including a biometric characteristic security system.

### BACKGROUND OF THE DISCLOSURE

Modem vehicles include various electronic control units, such as microprocessors and controllers, that are programmed to control vehicle operations. Such control units include, for example, an Electronic Control Module (ECM) or on-board computer. The control units are designed to monitor the operation of various electronic components and electronics in order to optimize vehicle performance. For example, control units such as an ECM can monitor the amount of carbon monoxide in the engine exhaust and adjust the fuel/air ratio entering the cylinders in order to optimize combustion efficiency.

When multiple control units are available, they are typically interconnected so that certain key data is globally available. The data can be accessed by a user through an information port. Diagnostic systems are commonly used to obtain (and sometimes transmit) data through the information port. Accordingly, the diagnostic system can be used to monitor and adjust the operation of various systems of the vehicle, and also detect malfunctions.

Traditional diagnostic systems are provided in the form of units that are coupled to the information port by means of a data cable. The large diagnostic systems typically include a computer, a monitor, and a keyboard. Smaller, portable diagnostic systems are also now available. For example, U.S. Pat. No. 6,693,367, which is assigned to the assignee of the present application, shows a portable, hand-held vehicle diagnostic display unit that is configured such that a user can simultaneously lift and operate the diagnostic display unit with a single hand.

To discourage theft and to generally provide electronic security, it may be desirable to include a security device with the automotive diagnostic display unit. A typical security device may permit a user to enter a code or identifier (password, pass-phrase, personal identification number or “PIN”) to electronically lock and/or unlock the unit so that only an authorized can not operate the device. Other security systems rely on a physical key such as a mechanical key or electronic key card or smart card in order to control who is granted access.

Security systems that rely upon an identifier (i.e., a password, pass phrase, or PIN) typically suffer from the drawback that a user must be able to provide the identifier. If the user loses or forgets the identifier, the user is denied access. Security systems that rely upon a physical key suffer from the drawback that keys, key-cards and smart cards are frequently lost or stolen thereafter precluding a legitimate user's access. Both the identifier and the physical key are inconvenient in that they require the user to actively use the identifier or the physical key prior to using the unit utilizing the security device.

Instead of passwords or keys, biometric characteristics (e.g., finger prints, retinal scans and voice “prints”), which uniquely identify an individual, can be effectively used to reliably identify an individual and do not suffer from the aforementioned drawbacks of electronic security systems that use identifiers or physical devices. Security systems that use biometric characteristics have an advantage in that an authorized user presumably never loses his or her finger prints, retinas or voice characteristics. Security systems that use biometric characteristics also can be adapted for passive or automatic detection by the system.

Accordingly, there exists a need for an automotive diagnostic display unit having a security device that permits only an authorized user to operate the display unit. Preferably, the security device will automatically determine if the user is authorized when the user operates the automotive diagnostic display unit so that the user does not have to actively engage the security device, such as by needing to enter a security code.

### SUMMARY OF THE DISCLOSURE

The present disclosure provides a vehicle diagnostic display unit including a case, a display screen disposed within a front portion of the case, and a main support coupled to a side of the case and having a finger compartment for receiving a user's finger to allow the user to lift the vehicle diagnostic display unit using one hand. A navigation pad is disposed on a front surface of the main support, and the main support is configured to allow a user to simultaneously lift the diagnostic display unit and access the navigation pad with a thumb. The display unit also includes a fingerprint identification system including a scanner for scanning an image of a fingerprint of the user. The scanner is fitted on the navigation pad so that the user's thumb naturally rests on the fingerprint scanner when the user lifts the diagnostic display unit and accesses the navigation pad with the thumb.

Among other features and benefits, an automotive diagnostic display unit constructed in accordance with the present disclosure includes a security device that permits only an authorized user to operate the display unit. Moreover, the security device automatically determines if the user is authorized as the user operates the automotive diagnostic display unit.

Additional aspects and advantages of the present disclosure will become readily apparent to those skilled in this art from the following detailed description, wherein only an exemplary embodiment of the present disclosure is shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Reference is made to the attached drawings, wherein elements having the same reference character designations represent like elements throughout, and wherein:

FIG. 1 is a front perspective view of an exemplary embodiment of a hand-held automotive diagnostic display unit including a fingerprint scanner incorporated into a pointing device of the diagnostic display unit;

FIG. 2 is a front elevation view of the hand-held automotive diagnostic display unit of FIG. 1;

FIG. 3 is a rear elevation view of the hand-held automotive diagnostic display unit of FIG. 1;

FIG. 4 is a bottom plan view of the hand-held automotive diagnostic display unit of FIG. 1;

FIG. 5 is a top plan view of the hand-held automotive diagnostic display unit of FIG. 1; and

FIG. 6 is a flow chart illustrating an exemplary embodiment of a method according to the present disclosure of operating the hand-held automotive diagnostic display unit of FIG. 1.

### DETAILED DESCRIPTION OF AN EXEMPLARY EMBODIMENT OF THE DISCLOSURE

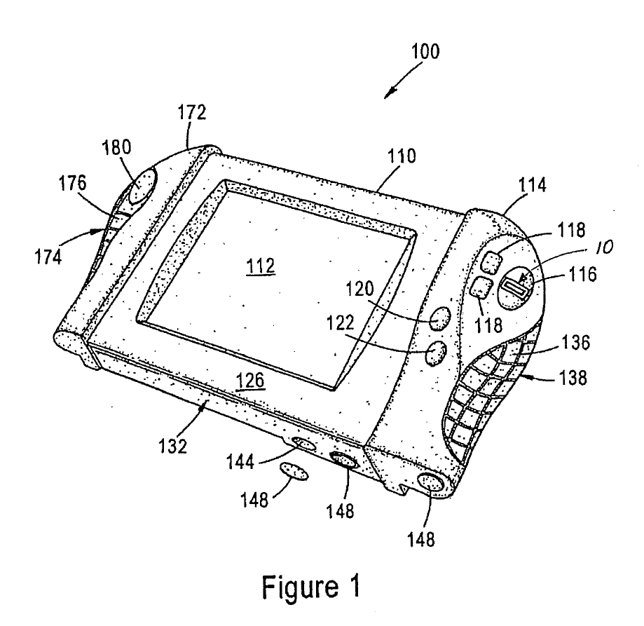

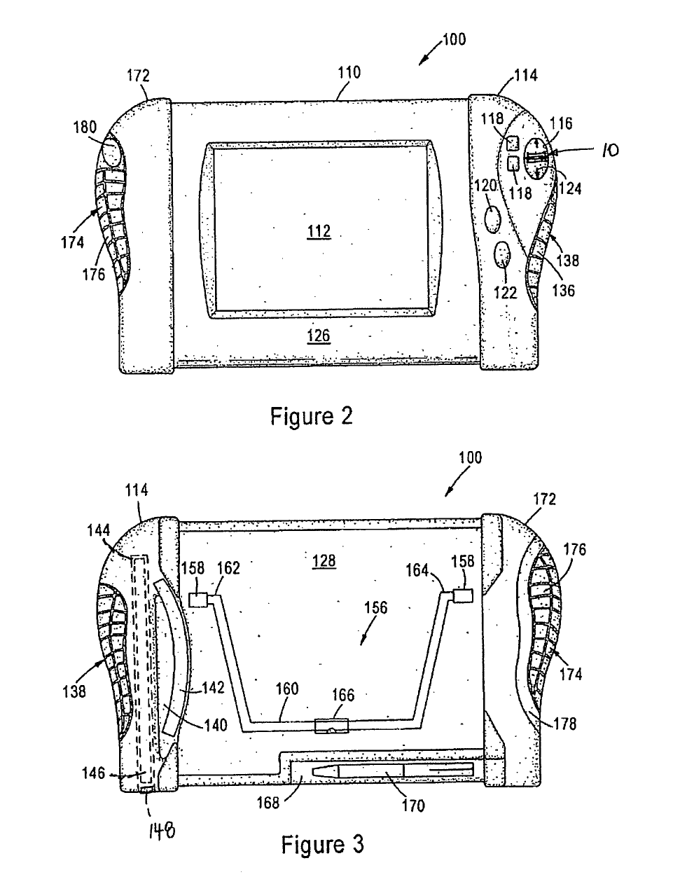

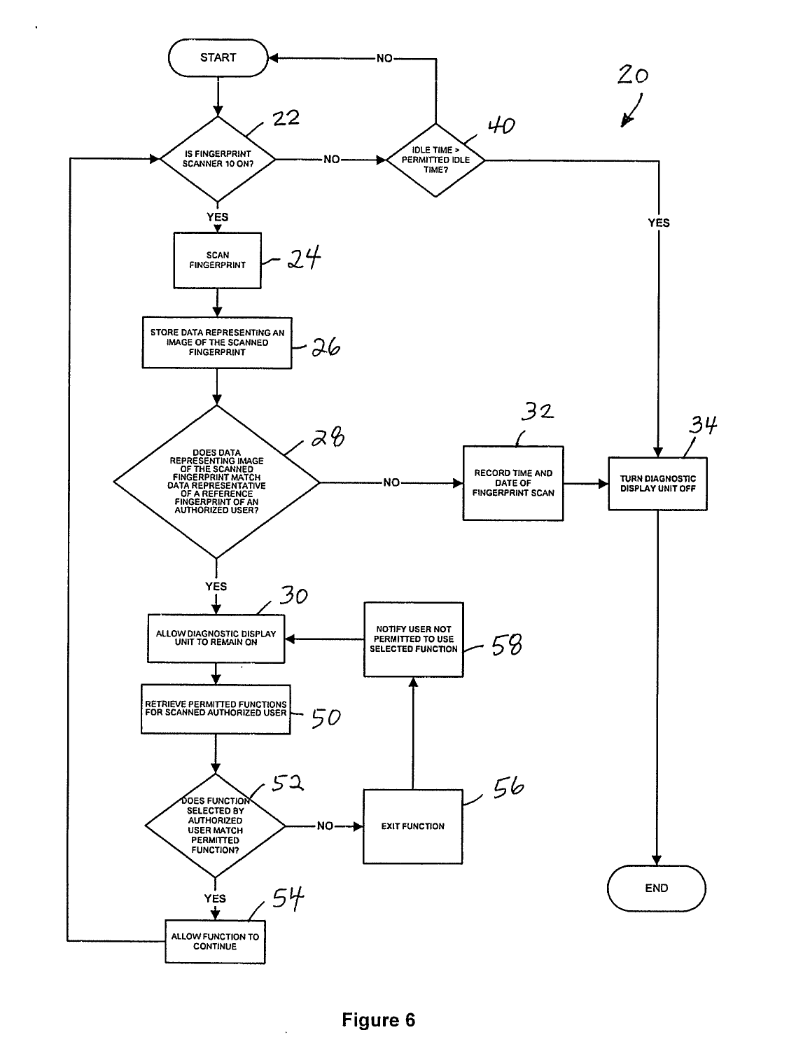

Turning now the drawings, and initially to FIGS. 1 and 2, there is shown an exemplary embodiment of a vehicle diagnostic display unit 100 constructed in accordance with the present disclosure. The diagnostic display unit 100 includes a fingerprint identification system including a scanner 10 for scanning an image of a fingerprint of a user of the unit 100 to ensure that the user is authorized to use the display unit 100. The scanner 10 is fitted on a navigation pad 116 of the unit 100 so that the user's thumb naturally rests on the fingerprint scanner 10 when the user lifts the diagnostic display unit 100 and accesses the navigation pad 116 with the thumb. FIG. 6 shows an example of a method 20 according to the present disclosure of operating the hand-held automotive diagnostic display unit 100 of FIG. 1 using the fingerprint scanner 10.

Referring first to FIGS. 1-5, the diagnostic display unit 100 includes a case 110, a display screen 112, a main support 114, and a plurality of keys 116-122 disposed on the main support 114. The case 110 is in the form of a generally rectangular housing that includes a front portion 126, a rear portion 128 (best seen in FIG. 3), a top portion 130, (best seen in FIG. 5) and a bottom portion 132. The diagnostic display unit 100 is described in U.S. Pat. No. 6,693,367, which is assigned to the assignee of the present application and incorporated herein by reference.

As illustrated in FIGS. 1-2, the display screen 112 is mounted within the front portion 126 of the diagnostic display unit 100. In order to protect the display screen 112 and various circuitry within the diagnostic display unit 100 from damage resulting from potential impact, a shock mounting arrangement is used to mount the display screen 112. As used herein, the shock mounting arrangement refers to an arrangement wherein shock absorption materials is interposed between the various layers of circuitry and/or components within the case 100. For example, shock absorption rubber or foam can be disposed between the display screen 112 and the case 110 in order to absorb any vibration or shock resulting from impacts such as dropping of the diagnostic display unit 100. According to such an arrangement, if a user accidentally drops the diagnostic display unit 100, the display screen 112 and associated circuitry will not be damaged. Preferably, the type of shock absorption material used in constructing the shock absorption arrangement is selected such that the diagnostic display unit 100 can withstand a fall from a height of at least five feet without suffering any damage. In the exemplary embodiment shown, the display screen 112 is in the form of a liquid crystal display (LCD) screen. It should be noted, however, that various other types of display screens 112, such thin film transistor (TFT), touch sensitive, or gas plasma, can be used in place of the illustrated LCD display screen 112.

The main support 114 is coupled to a side of the case 110 to allow a user to hold and operate the diagnostic display unit 100 using one hand. According to one exemplary embodiment, the main support 114 is ergonomically designed based on the shape and contour of the hand. Specifically, the main support 114 is contoured to comfortably fit within the palm of the user when holding the diagnostic display unit 100.

The selection keys 116-122 disposed on the front surface of the main support 114 are used operate the diagnostic display unit 100. In the exemplary embodiment shown, the plurality of keys includes the navigation pad 116, a plurality of selection keys 118, a display adjustment key 120, and a power key 122. The navigation pad 116 is in the form of directional thumb pad. By applying pressure along different portions of the navigation pad with the thumb, the user can navigate a cursor, not shown, on the display screen 112 through various menus. According to one exemplary embodiment, the navigation pad 116 is also pressure sensitive and the cursor can be moved at varying speeds based on the amount of pressure applied to the navigation pad 116. The navigation pad 116 can also be provided with directional arrows 124 imprinted on the surface thereof.

The selection keys 118 allow an operator to make various selections within the menus displayed on the display screen 112. For example, the selection keys 118 can consist of a “yes” key and “no” key. In operation, the user would navigate the cursor to a particular item, or entry, and utilize the “yes” key to accept the entry or access an additional menu. The “no” key can be used, for example, to reject a selection or navigate to a previous menu screen. The diagnostic display unit 100 also includes a power key 122 that allows the user to turn the diagnostic display unit 100 on and off. A display adjustment key 120 can also be provided to adjust various features, such as contrast, of the display screen 112.

A user can advantageously hold and operate the diagnostic display unit 100 using a single hand. This allows the user to utilize their free hand to access various items, or take notes, during the diagnostic process. Additionally, such a one-handed construction allows the user to quickly view and operate the diagnostic display unit 100 while, for example, working under the hood of the vehicle.

With continued reference to FIGS. 1-5, the main support 114 also includes a palm rest 138 formed thereon, and a finger cavity or compartment 140 formed on the rear surface thereof. The finger cavity or compartment 140 extends a prescribed distance into the main support 114 to further improve the user's ability to grip the main support 114. Specifically, when the user grabs the main support 114, the palm rest 138 is designed to comfortably fit into the palm of the user, while the fingers are wrapped around the main support 114 and extended into the finger cavity or compartment 140. Accordingly, a tight and secure grip can be achieved.

A knuckle guard 142 is also formed on the side of the case 110 adjacent to the finger cavity or compartment 140. The knuckle guard 142 is designed to engage the knuckle portion of the user's hand when the diagnostic display unit 100 is being held. The combination of the knuckles bearing on the knuckle guard 142 and the fingertips bearing on the inside of the finger cavity 140 allows the user to support the display unit 100 without the need to use the thumb. The combination allows the user the freedom of moving his thumb freely for operation of the thumbpad 116 and/or selection keys 118.

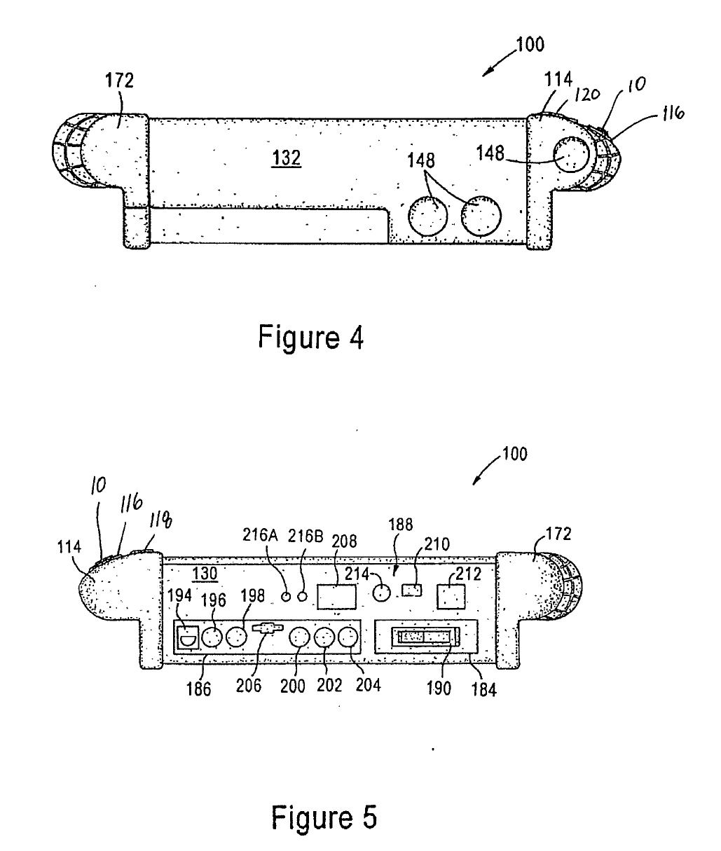

As illustrated in FIG. 1, the diagnostic display unit 100 of the present disclosure can include at least one power supply compartment 144 to allow cordless operation. FIG. 4 illustrates an exemplary embodiment of the bottom portion 132 of the case 110. In FIG. 4, the power supply compartments are shown closed with covers 148. Depending on the particular design and configuration, the number of power supply compartments 144 can vary so that a sufficient amount of current can be supplied to the display screen 112 and circuitry disposed within the diagnostic display unit 100. Preferably, a single power supply compartment 144 is disposed within the main support 114. One or more power cells 146, as illustrated in FIG. 3, are then provided within the power supply compartment 144 to supply power.

FIG. 5 illustrates an exemplary embodiment of the top portion 130 of the case 110 and various components and connectors. Specifically, the top portion 130 includes a primary adapter 184, a secondary adapter 186, and a connection panel 188. The primary adapter 184 includes a primary connector 190, such as a high density d-type connector, disposed therein. The primary connector 190 is intended for receiving a cable (not shown) that is coupled to the vehicle's ECM or on-board computer. Accordingly, the primary connector 190 includes individual wires for receiving and transmitting various signals to and from the on-board computer. The primary adapter 190 is recessed into the top portion 130 in order minimize potential damage that can result from impacts.

According to one embodiment, the diagnostic display unit 100 includes a charging circuit disposed within the case 100. The charging circuit functions to supply a charge to the rechargeable power cells 146 when the diagnostic display unit 100 is electrically coupled to the vehicle via the primary adapter 190.

The secondary adapter 186 includes a plurality of secondary connectors disposed therein. Similar to the primary connector 190, the secondary connectors are recessed within the secondary adapter 186 in order to minimize potential damage resulting from impact. The secondary connectors are provided for exchanging data and various signals with external components or vehicle components other than the on-board computer. For example, the secondary adapter illustrated in FIG. 5 includes a DIN-9 connector 194, a first input connector 196, a second input connector 198, a first output connector 200, a second output connector 202, and an auxiliary connector 204. The secondary connectors provided on the secondary adapter 186 are capable receiving and exchanging data as well as analog and/or digital signals. The diagnostic display unit 100 can also include a fuse 206, as illustrated in FIG. 5, to prevent damage internal circuitry in the event of a voltage or current overload.

The connection panel 188 also includes a plurality of connectors for exchanging data and signals with external devices. As illustrated in FIG. 5, the connection panel includes a RS-232 port 208, a universal serial bus (USB) port 210, and an Ethernet port 212. All three ports 208-212 are intended for exchanging data and signals. The connection panel 188 also includes a power supply connection 214 for connecting the diagnostic display unit 100 to an external power source. Accordingly, if internal power cells 146 are unavailable or incapable of supplying the requisite power to drive the components, the external power supply 214 can be provided to power the diagnostic display unit 100. A pair of light emitting diodes (LEDs) 216A, 216B, are also provided on the top portion 130 and function as status indicators for the diagnostic display unit 100.

As previously stated, the primary adapter 184 is intended for connection to the vehicle's on-board computer, while the secondary adapter 186 and connection panel 188 allow data and electrical signals to be exchanged with external components and other vehicle components. Accordingly, it is not necessary to provide the secondary adapter 186 and connection panel 188 in order to obtain an operational diagnostic display unit 100.

Although not shown, the diagnostic display unit 100 can include at least one expansion slot provided within the case 110. The expansion slot is provided for upgrading or improving various features of the diagnostic display unit 100. Such features can include, for example, volatile memory, non-volatile memory, a modem interface, etc. Such a feature advantageously allows the user to upgrade and improve the features of the diagnostic display unit 100, thereby extending its usable technological life. In other words, rather than replacing the diagnostic display unit 100 for a newer model, the expansion cards can be used to upgrade the features of an aging diagnostic display unit 100.

Referring to FIGS. 1, 2, 4 and 5, the fingerprint scanner 10 is fitted on the navigation pad 116 of the unit 100 so that the user's thumb naturally rests on the fingerprint scanner 10 when the user lifts the diagnostic display unit 100 and accesses the navigation pad 116 with the thumb. The fingerprint scanner 10 can comprise for example, but is not limited to, an EntréPad® AES2510 fingerprint sensor, which is available from AuthenTec, Inc. of Melbourne, Fla. (www.authentec.com). A fingerprint identification system advantageously provides unique personal user identification.

Although not shown, the fingerprint identification system further comprises a first memory device, a second memory device and a processor. The first memory device stores data representative of the image of the fingerprint as obtained by the fingerprint scanner 10. The second memory device stores data representative of at least one reference fingerprint of an authorized user. The processor is programmed to determine whether the data representative of the image of the scanned fingerprint matches the data representative of the reference fingerprint.

FIG. 6 shows an example of a method 20 according to the present disclosure of operating the hand-held automotive diagnostic display unit 100 of FIG. 1 using the fingerprint scanner 10. The method 20, which is carried out by a central processing unit (CPU) of the diagnostic display unit 100, includes determining whether the fingerprint scanner 10 is on, as shown at 22. The fingerprint scanner is on when a user's thumb is positioned on the fingerprint scanner 10 and pressure is applied to the scanner. If the finger print scanner is on, then a fingerprint scan is taken, as shown at 24, and the data representing an image of the scanned fingerprint is stored, as shown at 26. Although not shown, the data representing an image of the scanned fingerprint can be stored in a first memory device.

Still referring to FIG. 6, the method 20 then includes comparing the data representing an image of the scanned fingerprint to data representative of a reference fingerprint of an authorized user, as shown at 28. Although not shown, the data representative of a reference fingerprint of an authorized user can be stored in a second memory device. The data representative of a reference fingerprint of an authorized user is obtained during an enrollment procedure. In an enrollment procedure a new authorized user teaches the system how to recognize the new authorized user. In fingerprint systems, for example, the new authorized user typically places his or her finger several times on the fingerprint sensor 10, allowing the system to memorize his fingerprint, and store the data representative of a reference fingerprint of the new authorized user.

If the data representing an image of the scanned fingerprint does match the data representative of at least one reference fingerprint of an authorized user, then the CPU of the diagnostic display unit 100 allows the display unit to remain on, as shown at 30 of FIG. 6, so that the authorized user can continue operating the unit 100. If the data representing an image of the scanned fingerprint does not match the data representative of at least one reference fingerprint of an authorized user, then the CPU of the diagnostic display unit 100 is programmed to turn off the diagnostic display unit 100, as shown at 34, such that the unauthorized user cannot operate the unit 100. In the exemplary embodiment of the method 20 shown in FIG. 6, the CPU is also programmed to record or save the time and the date of the fingerprint scan, as well as the data representing an image of the scanned fingerprint, as shown at 32, if the data representing an image of the scanned fingerprint does not match the data representative of at least one reference fingerprint of an authorized user. That information can then be used to identify an unauthorized user that attempted to use the diagnostic display unit 100.

The method 20 may also include turning the diagnostic display unit 100 off upon not being used for a predetermined “idle” time. For example, in FIG. 6 the method 20 includes checking whether the fingerprint scanner 10 has not been turned on for an “idle” time greater than a permitted idle time, as shown at 40. The permitted idle time may be set at ten minutes, for example. If the idle time is greater than the permitted idle time, then the CPU is programmed to turn the diagnostic display unit 100 off, as shown at 34.

The method may additionally include restricting authorized users to select functions, or computer programs, available on the diagnostic display unit 100. For example, if the diagnostic display unit 100 includes a total of five functions or computer programs, one authorized user may be authorized to use all five functions or computer programs, while another other authorized user may be authorized to only use one of the five functions or computer programs. In such a case, the second memory device also stores at least one permitted function for each of the authorized users, and the permitted functions are listed during the enrollment procedure of a new authorized user. The enrollment procedure itself may be carried out by a computer program loaded onto the diagnostic display unit 100 as part of the fingerprint scanner 10, and a single user, or administrator, may be authorized to execute the enrollment program and enter the authorized function for each of the other users.

The processor is then programmed to permit the display unit 100 to perform a function selected by the authorized user upon determining that the selected function matches the permitted function stored for the authorized user, as shown for example at 50, 52 and 54 of FIG. 6. If, however, the processor determines that a function selected by the authorized user does not match at least one permitted function stored for that authorized user, then the processor is further programmed to exit (our simply not enter or load) the selected function, as shown at 56, and notify the user that he or she is not permitted to use the selected function, as shown at 58.

The present disclosure, therefore, provides an automotive diagnostic display unit including a security device that permits only an authorized user to operate the display unit. Moreover, the security device automatically determines if the user is authorized as the user operates the automotive diagnostic display unit. It should be understood that the present disclosure is not meant to be limited to a fingerprint scanner and that other biometric identification systems can be alternatively used in accordance with the present disclosure. Other suitable biometric identification system include, for example, face-recognition systems, retinal scanners, and voice scanners.

The specific methods and apparatus described in this specification have been presented by way of illustration rather than limitation, and various modifications, combinations and substitutions may be effected by those skilled in the art without departure either in spirit or scope from this disclosure in its broader aspects and as set forth in the appended claims. All methods and apparatus disclosed herein, and all elements thereof, are contained within the scope of at least one of the following claims. No elements of the presently disclosed methods and apparatus are meant to be disclaimed.

What is claimed is:

1. A vehicle diagnostic display unit comprising:
a case;
a display screen disposed within the case;
a main support coupled to the case and having a finger compartment for receiving a user's fingers to allow the user to lift the vehicle diagnostic display unit using one hand;
a navigation pad disposed on the main support, wherein the main support is configured to allow a user to simultaneously lift the diagnostic display unit and access the navigation pad with a thumb; and
a fingerprint identification system including a scanner for scanning an image of a fingerprint of a finger or the thumb of the hand, wherein the scanner is fitted on the navigation pad so that the user's thumb naturally rests on the fingerprint scanner when the user lifts the diagnostic display unit and accesses the navigation pad with the thumb.

2. A vehicle diagnostic display unit according to claim 1, wherein the fingerprint identification system further comprises:
a first memory device for storing data representative of the scanned image of the fingerprint;
a second memory device for storing data representative of a reference fingerprint for at least one authorized user; and
a processor determining whether the data representative of the scanned image of the fingerprint matches the data representative of the reference fingerprint of the authorized user.

3. A vehicle diagnostic display unit according to claim 2, wherein the processor permits the display unit to continue operating upon determining that the data representative of the image of the scanned fingerprint matches the data representative of the reference fingerprint of the authorized user.

4. A vehicle diagnostic display unit according to claim 2, wherein the second memory device also stores at least one permitted function for the authorized user, and the processor permits the display unit to perform a function selected by the authorized user upon determining that the selected function matches the permitted function stored for the authorized user.

5. A vehicle diagnostic display unit according to claim 2, wherein the processor causes the display unit to shut down upon determining that the data representative of the image of the scanned fingerprint does not match the data representative of the reference fingerprint of the authorized user.

6. A vehicle diagnostic display unit according to claim 2, wherein the processor saves the scanned fingerprint and a time and date of scanning upon determining that the data representative of the image of the scanned fingerprint does not match the data representative of the reference fingerprint of the authorized user.

7. A vehicle diagnostic display unit according to claim 1, wherein the navigation pad is a directional thumb pad.

8. A vehicle diagnostic display unit according to claim 7, wherein the navigation pad is pressure sensitive.

9. A vehicle diagnostic display unit according to claim 1, further comprising at least one selection key positioned adjacent the navigation pad.

10. A vehicle diagnostic display unit comprising:
a case;
a display screen disposed on the case for providing information to a user;
a navigation pad disposed on the case for allowing a user to operate the diagnostic display unit;
a data input port configured to receive data relating to a condition of a vehicle; and
a biometric identification system including a biometric characteristic scanner for scanning a biometric characteristic of a user when the user operates the diagnostic display unit.

11. A vehicle diagnostic display unit according to claim 10, wherein the biometric identification system further comprises:
a first memory device for storing data representative of the scanned biometric characteristic of the user;
a second memory device for storing data representative of a reference biometric characteristic for at least one authorized user; and
a processor determining whether the data representative of the scanned biometric characteristic matches the data representative of the reference biometric characteristic of the authorized user.

12. A vehicle diagnostic display unit according to claim 11, wherein the processor permits the display unit to continue operating upon determining that the data representative of the scanned biometric characteristic matches the data representative of the reference biometric characteristic of the authorized user.

13. A vehicle diagnostic display unit according to claim 11, wherein the second memory device also stores at least one permitted function for the authorized user, and the processor permits the display unit to perform a function selected by the authorized user upon determining that the selected function matches the permitted function stored for the authorized user.

14. A vehicle diagnostic display unit according to claim 11, wherein the processor causes the display unit to shut down upon determining that the data representative of the scanned biometric characteristic does not match the data representative of the reference biometric characteristic of the authorized user.

15. A vehicle diagnostic display unit according to claim 11, wherein the processor saves the scanned biometric characteristic and a time and date of scanning upon determining that the data representative of the image of the scanned biometric characteristic does not match the data representative of the reference biometric characteristic of the authorized user.

16. A vehicle diagnostic display unit according to claim 10, wherein the biometric characteristic comprises a fingerprint.

17. A vehicle diagnostic display unit according to claim 16, wherein the scanner is located on the navigation pad.

18. A vehicle diagnostic display unit according to claim 11, wherein the navigation pad is pressure sensitive.

19. A vehicle diagnostic display unit according to claim 1 1, wherein the processor is programmed to cause the display unit to shut down upon determining that the fingerprint scanner has not been turned on for an idle time greater than a permitted idle time.

20. A vehicle diagnostic display unit according to claim 10, further comprising a main support coupled to the case, wherein the main support is configured to allow a user to simultaneously lift the diagnostic display unit using one hand and access the navigation pad with a thumb of the hand, and wherein the biometric scanner is fitted on the unit so that the user is examined by the biometric identification system when the user lifts the diagnostic display unit with one hand and accesses the navigation pad with the thumb.

21. A vehicle diagnostic display unit according to claim 10, wherein the data input port comprises a connector disposed on the case for receiving a cable coupled to a vehicle's on- board computer.

22. A vehicle diagnostic display unit according to claim 2, wherein the processor is programmed to cause the display unit to shut down upon determining that the fingerprint scanner has not been turned on for an idle time greater than a permitted idle time.

23. A vehicle diagnostic display unit according to claim 1, further comprising a data input port configured to receive data relating to a condition of a vehicle.

24. A vehicle diagnostic display unit according to claim 4, wherein the second memory device stores data representative of reference fingerprints for multiple authorized users and at least one permitted function for each of the authorized users.

25. A vehicle diagnostic display unit according to claim 24, wherein the data representative of the reference fingerprint and the permitted functions for each of the authorized users is entered into the second memory device through an enrollment program carried out by a designated administrator.

26. A vehicle diagnostic display unit according to claim 13, wherein the second memory device stores data representative of reference fingerprints for multiple authorized users and at least one permitted function for each of the authorized users.

27. A vehicle diagnostic display unit according to claim 26, wherein the data representative of the reference fingerprint and the permitted functions for each of the authorized users is entered into the second memory device through an enrollment program carried out by a designated administrator.
